(19) United States
(12) Patent Application Publication
(10) Pub. No.: US 2002/0179354 A1
(43) Pub. Date: Dec. 5, 2002

(54) Extended range electric vehicle

(75) Inventor: Donald Joe White, Russellville, AR (US)

Correspondence Address: Donald J. White, 1212 South Muskogee Avenue, Russellville, AR, 72801, US

(73) Assignee: Sail D. White Enterprises, Inc.

(21) Appl. No.: 10/165,704

(22) Filed: Jun. 8, 2002

Related U.S. Application Data
(63) Continuation-in-part of application No. 09/562,011, filed on May 2, 2000, now abandoned.

(51) Int. Cl. B60K 8/00

(52) U.S. Cl. 180/165; 180/65.2

(57) ABSTRACT

An extended range E-V uses a compressed energy system to power a flywheel having an internal battery with a ball-mounted axle, for recharging of the main battery, by driving a generator. The flywheel coupled within the vehicle uses the leverage end of the axle, a bearing coaxially surmounted by an elastic medium, actuators, and a pivotally coupled sub-carriage for stability. The flywheel comprises a power take off gearing means within the ball to drive a generator for supplementing the electrical power in the batteries. A catch releases compressed energy to initiate motion of the flywheel that allows the E-V battery to be recharged while the E-V is in operation. A retractable sliding contact provides the path for the compressed energy absorber to receive energy from an advocated bus in the roadway, to be rapidly charged while stopped at a station, or while E-V is moving slowly.

### BACKGROUND OF THE INVENTION

I. Field of the Invention

The present invention relates generally to mechanical energy absorbing devices being used to store energy for use in actuating a flywheel for on-board power generation. More specifically, the invention relates to a cascaded system of energy storage, impact damping, energy conversion devices that are normally oriented on the vehicle or coupled adjacent to the vehicle for utilization as an energy storage device that obtains its energy from a utility energy supply source and contributes power to extend the range of an electric vehicle. The present invention relates generally to recharging electric vehicles on-the-go with the compressed potential energy from a mechanical device such as my impact absorbing, load decelerating device to power a recharge system for electric vehicles to allow them to recharge the battery while E-V travels. Thereby, reducing the problem of recharging infrastructure to an opportunity for electric utilities.

More specifically, the invention relates to a means of cascading energy absorbing and transmission devices such that is oriented to respond to high power, quick mechanical charging of springs or elastic material, from an outside source such as the utility distribution grid, and release this energy in fractional increments through a gearing and flywheel means to drive a generator to recharge the E-V battery later, over a longer period of time.

This invention relates to an electric vehicle flywheel—battery combination that overcomes the technical barriers of both, which have in the past prevented its use, in addition to being a supplier of stored electrical energy, to be used also as a flywheel to drive a generator. The flywheel has a special mounting configuration for freedom of movement in dynamic conditions.

Obviously, large, heavy flywheels require some inertia considerations and offer problematic gyroscopic effects. Supplying power in quantities large enough to significantly contribute to the increasing of the E-V range could be dangerous if released all at once. (For example, if a bearing seized up, the high speed flywheel inertia could contribute to an accident; or road turns and irregularities would fight the gyroscopic forces of a high speed flywheel). Also, problems with E-V battery placement at the ends (out of the way of the passenger compartment) causes directional inertia characteristics which are different from what most drivers are accustomed due to the remotely positioned mass densities.

Several opportunities exist to prevent the E-V user from the necessity of waiting long enough for the E-V battery to recharge: removing the main battery and drive locally on auxiliary batteries and active generator while main battery is being recharged at the proper rate; recharge an energy storage system quickly and drive away as batteries are recharging; one could use an advocated “in the traveled way bus power supply” to electro-mechanically recharge the storage system from an electrical grid distribution facility provided for that purpose at rest areas or designated stations.

II. Description of the Prior Art

In part because of rising fuel costs, the need to protect our environment, and the desire for less dependence on foreign oil, has led to increasing attention has been directed to flexible fuel vehicles (i.e., “FEV's”) for clean burning, low, super-ultra low emissions vehicles, and zero emissions vehicles (i.e., “ZEV's”) power systems. Such vehicles are characterized by clean-burning, low emission exhausts. Motor vehicles employing hybrid power train systems to drive the vehicle are well known in the art. A hybrid electric vehicle (i.e., “HEV”) utilizes electrical energy for an energy source and an auxiliary power unit (APU), most often an internal combustion engine (ICE), as the other source. Various strategies have been developed for operating the electric motor in hybrid vehicles. Generally, the HEV has either a series or parallel configuration, based upon how the APU is utilized.

Other configurations are fuel cell electric vehicles, flywheel electric vehicles and the battery only electric vehicle, (i.e., “BOEV's”). The problem with the BOEV is with its inability to serve well for long trips.

Electric Vehicles have had problems with their range and with limited battery life. Part of the problem with battery life is deep cycling, draining too much power out before recharging. Another problem relates to quick charging, as damage can result where one attempts to totally recharge a battery over too short a time period. Owners of such vehicles typically want to travel as far as they can and be ready to go again as soon as possible. At the same time, if a surplus of extra battery power is provided, the weight lowers efficiency and increases cost. Another problem with the commercialization of modern E-V's is the lack of a supportive, nationwide infrastructure, and the common availability of standardized recharge systems and locations for Electric Vehicles.

Service or recharge stations are faced with E-V's coming to a service/recharge station with numerous different sizes, types, age, condition and state of charge. The opportunity for mistakes, human performance errors during the required recharging is high. Recharging at the wrong rate or for the wrong length of time, can adversely affect battery life or cause unnecessary delays and even affect safety.

In prior recent years E-V's had a large percentage of their weight located (in high densities) at the opposite ends of the vehicle, i.e. with the batteries in the rear and the motor and controls and additional batteries in the front for balance and passengers near center. This adversely affected the straight line inertia and the maneuverability and handling characteristics. For example, the ability to react sharply to sudden traffic conditions, particularly on slick roadways, was compromised. Another problem is crashworthiness. This design factor has not been paramount, since priorities then emphasized weight savings, cost savings, simplicity and reliability.

Now however, a high energy absorber for restarting the flywheel (which is already on board) may also serve as a life-safety bumper, and can better justify its weight and cost by serving a double function, as an energy release device for running a generator/alternator/charger to recharge the battery, and a standby impact absorber for the bumper.

Prior art E-V's do not show how large amounts of mechanical energy can be stored on the vehicle and be releasable for use on demand in very small usable increments to recharge a smaller, secondary mechanical energy storage system, to drive a flywheel, to generate power. Some have thought of super capacitors in conjunction with regenerative braking to harness energy. obviously, large, heavy flywheels require some inertia considerations and offer problematic gyroscopic effects.

Prior art devices do not allow recharging of E-V batteries while the motor is in operation by a separately driven incrementally powered flywheel/battery units by best known prior art.

The known prior art does not adequately address the need for an efficient, quick operating, suspension retractor for electrical contacts for the E-V to draw power through automatically or selectively engaged sliding contacts from a bus in the roadway for a separate onboard mechanical charging system. While the prior art systems do not intentionally shift the retractable brushes of the electric vehicle to a position to contact the envisioned contacts in special portions of roadway bus work provisions for rapid charging of an onboard mechanical system; or for drive through power stations that supply power independent of the main battery.

### SUMMARY OF THE INVENTION

This present E-V may get its energy at home or at a recharge station or from special busworks provided in the roadway/rest areas/utility substation providers.

This present invention uses a compressed energy system and a flywheel with special gearing to serve as APU, not an internal combustion engine, (ICE), having this to drive the wheels with electric power from the batteries. This invention will show a configuration, i.e. the APU has a flywheel/battery that may be linked to the main battery in series with the main battery or as voltages allow, selectively in parallel with a portion of the battery for a part of the discharge cycle to control localized battery heating and depth of discharge and reduce the duration of sustained continuous load on the battery. The flywheel being specifically designed to comprise rechargeable battery cells; whereas these cells may be manufactured of the wet type, as part of the flywheel with electrolyte that migrates to the gravitationally lower level while the flywheel is at rest and is pumped by centrifugal means to the circumference when the flywheel is in rotary motion, thereby reducing the starting inertia of the flywheel; but also to immerse the plates more completely for higher current output capability for short interim use in series with portions of the main battery bank. This flywheel being mounted such that its plane of rotation may be allowed to vary and transmit the gyroscopic forces to the vehicle in different ways according to the magnitude and direction of the forces relative to the E-V, by using elastic bearing casing on the opposite (or leverage) end and actuators or shock absorbers; and a mounting of the unit onto a separate sub-carriage framework of the vehicle coupled by additional springs and pivot point.

Also, the quick change-out of the battery bank was difficult and the weight of the battery mandates the requirement of stiffer spring suspension. However, using portions of the articulated mechanism from my original patent (reference U.S. Pat. Letters No. 5,788,186) and adding wheels to the sub-carriage, like my Articulated Trailer Device, U.S. Pat. No. 5,295,703 along with some quick disconnect power as an attachment for the battery to ride on an isolated carriage, the change-out would require only to drop a dolly wheel, disconnect mechanically the framework and connectors and the used battery would roll right out for a newly recharged one to roll right back in.

Whereas, my previous invention U.S. Pat. IMPACT ABSORBING APPARATUS, shows a substantially fixed position bumper with a designated path to retract with impact and remain captured, following severe impact until gradually released by personnel following a procedure. This E-V range extender uses a similar compressed energy absorbing mechanism but, now also provides an automatic means of releasing the compressed energy in fractional increments small enough to be harnessed for the output of desired work; and in small enough increments as to not pose a safety threat to passengers/occupants or attendants near by; and to manage the gyroscopic effects of the flywheel at low enough magnitude so as not to cause unexpected vehicular behavior in sharp turns.

A special flywheel construction is described such that a significant portion of the flywheel weight is from components the make up a storage battery, so that the weight necessary for the flywheel will serve a multiple purpose: to be a flywheel; to be an auxiliary battery, for use in series with a portion of main battery and to either replace the remaining portion or to momentarily be placed in parallel to the remaining portion of the main battery, i.e. to allow selectively reduced load on a few cells to reduce overheating and to enhance battery health. When short term higher performance is desired, or selected to be used when the main battery's charge is nearing depletion more specific load sharing accommodations may be applied. And flywheel acts as a soft start flywheel with optimized variable inertia to drive a generator/alternator/battery charger. At rest the flywheel's electrolyte flows to a reservoir nearer the center and offers less resistance at the onset of rotary acceleration; but quickly, centrifugal forces drive the liquid toward the circumference, over a partial barrier operate with its weight along the circumference for more power.

The present New E-V Range Extender encompasses several methods of alleviating the undesired effects of inertia for a maneuverable motor vehicle and some methods of utilizing inertia to extend the distance that an E-V can travel without stops of long duration for battery recharging. A flywheel and a separate pivoted battery carriage each allow the inertia in the direction of the E-V wheel path to be temporarily independent of the tendency of the straight line inertia forces evident from the effects of the flywheel or the high density battery that powers the electric vehicle.

Using two of the three plane motions in my Helicopter External Load Suspension Device as a contemplated means to allow suspension movement separate from the passenger portion of the vehicle a slightly offset direction would be applicable in making sharp turns where the passenger portion of the E-V could alter its direction separately from the carriage with the weight of the battery. When backing up one pivot could be locked straight to prevent jackknifing and/or changing relative spring loads to put more weight on the middle set of wheels. (It is also contemplated to use this said suspension on each side for the middle set of wheels to articulate the width for a very high mobility HEV, hybrid electric military Internally Transportable Vehicle.)

Showing the flywheel operating in a less restrictive bearing support environment allows dissipation and/or delay of some of the objectionable characteristics of prior art flywheels used on motor vehicles for high way applications. Showing the flywheel on forced response to the actuators allows dynamic load shift characteristics for enhanced handling thus enhanced mobility in compliment to active suspension system future vehicles.

Whereas, in my present system the retractable contacts obtain current to quickly recharge the compressed energy absorber system(s) and would not immediately affect the power to the drive motor(s) or the battery voltage; but only the motorized tool that recharges the absorber.

My preferred New E-V Range Extender Device also employs the teachings of my prior U.S. Pat. No. 5,947,538, which is hereby incorporated by reference shows a substantially fixed bumper that retracts in response to impact. The device remains compressed until it is gradually released by service technicians. My New E-V Range Extender uses a similar, compressed energy absorbing mechanism that automatically releases compressed energy in fractional increments small enough to be harnessed for the desired work. This captured energy, when released in fractional increments through a block and tackle mechanical advantage, gearing and a flywheel means act as a prime mover for driving a generator for recharging the E-V battery.

To supply additional power for when a battery needs to be recharged, immediate extra power is desired, and when no time is permitted for normal recharge, this energy absorber is quickly mechanically compressed and later released through a gearing and flywheel means to provide a slow rate of charge as needed. Of course when there is opportunity to start out with both a fully charged battery and a fully compressed energy absorber, a longer range of uninterrupted travel time and distance will be the result.

My invention provides energy release and compressed energy absorbing means that can handle a broader range of useable energies (in small step quantities) than can the prior art. A “block and tackle mechanical advantage” is provided by a wound band assembly that converts the low velocity springs/disc springs (or other elastic material) to a greater operating distance for numerous incremental releases to provide high enough rotating velocity for the gears and flywheel with PTO, power take off drive-line to drive the generator/alternator/battery charger. When mechanical charging forces compresses the absorber system the energy is captured for release by the catch devices. The conversion technique enables the system(s) to use a particularly high energy density disc spring or other elastic medium (offering good service life at slow operating speeds), as it functions adequately within the limited range of motion of production disc springs or elastic absorbers.

The wound band assembly comprises a resilient band that is wound about a number of pulleys; a means of applying the energy from an outside source; a catch means to hold the energy in the ready for use condition; and a means of releasing the energy into useable motion. When the absorber is compressed (if by impact), a rod projecting from it is deflected to actuate the wound band assembly, dissipating considerable energy. When the absorber is compressed by the tool, the band momentarily becomes slack and the slack is taken up by a carrier spring and a springed ratchet winch which is positioned to link to the ram at the tightest position available.

In order to have more total power a longer stroke is contemplated. Therefore the band to ram attachment point is permissibly altered at the release of each increment of power to maintain a maximum bumper deflection of approximately 20 inches to only minimally affect the overall characteristics while in normal recharge mode. This is done by a typical ratchet winch mechanism to take an appropriate amount of the band by winding it up on its spool before the actuator plunges out another increment of power. However, it is contemplated to enhance impact safety also by using this mechanism and an “impending impact” signal to drive the front bumper out further to commence impact deceleration sooner upon impact and allow further movement prior to vehicle frame deformation and possible passenger compartment intrusion.

The band transmits horizontal movements at each stage increment to the first of the array of gears and a flywheel that eventually drive the generator/alternator/battery charger.

During the time period between minimum load and after full deflection an actuator releases the catches on the springed ratchet winch and the spring-loaded shackle dog assembly and sends the ram to band attachment back to the cocked position, takes up any excess slack from the band and continues to release the catch device to slam the full incremental load to the auxiliary recharge drive train via the wound band. During impact, the band's pulley will be retracted in a plane toward the lower ends of the energy absorbers to which it connects. These absorbers compress to absorb energy, but their compression deflection is much less than the deflection distance the bumper travels when impacted. A series of pulleys in a block and tackle arrangement coupled to suitable levers reduce the impact travel deflection to the limited distance the absorbers compress when absorbing energy. Preferably, the band may have a foot or more of travel at each increment to spin the flywheel and gearing, but a safety interlock is contemplated to prevent this actuation when the E-V is parked. Outside the vehicle front bumper orientation won't reveal this total travel distance due to the springed ratchet winch's response to maintain the distance to within unobjectionable parameters while the E-V is in motion.

The flywheel(s) will rotate about an axis and the mount will selectively be allowed to deviate a few degrees at a time about a vertical axis to prevent its gyroscopic inertia from adversely affecting the E-V's maneuverability.

If two conventional flywheels are used a horizontal mounting orientation (that would selectively be free to rotate about with respect to the longitudinal axis of the vehicle) would be considered; but contemplated are these flywheel/battery assemblies: 1)if more than one, mechanically driven at the same time, they would be in a stacked configuration; 2)if driven independently by opposite secondary systems, they would be located separately at a suitable location on the sub carriage that rotates about a pair of generally vertical axis to counter some major forces experienced with flywheels and gyroscopes following a direction change.

This would allow a multiple purpose for the weight of the battery; for the weight of the flywheel(s); for extra configurations to be selected: voltage to be added in series or subtracted or exchanged on main battery group portions to the drive motor when the main battery is drained to the extent that it no longer supplies full voltage to the drive motor (or as load capacities dictate, it is contemplated that it also may be part or all of the main power battery).

This flywheel/battery consists of these groups for the purpose of explanation: mechanical rotating mass; electrical (metallic); electrolyte; insulation and connections; cell containment; and safety containment. The mechanical rotating mass group would have shaft hole, key-way, inner circumference structural resistance barrier; multiple pass band attached to the outside circumference of a battery cell container on the fixed end with friction-slip on the visual indicator end, over-speed stress failure tell-tale, inner spacers and plate spacers and support consisting of a ball and socket pivot and a shaft radial bearing with a dampened mounting means. The electrical (metallic) group has the positive and negative plates of dissimilar metals shaped to be balanced about the inner circumference structural resistance barrier in the full speed operating mode with the structure retainer as the fulcrum and an arrangement of electrical similar plate connectors; posts and slip rings.

Alternate methods of fabrication include: cylindrical cells positioned end to end inside a coiled tube which is positioned around the circumference to facilitate individual cell change out and replacement; another method of fabrication includes mountings for COTS, commercial-off-the-shelf starved electrolyte E-V batteries with multiple cells to be attached in positions around the circumference and electrically connected and required. The electrolyte, as in the integral fabrication shown, would be a suitable liquid substance such as acid that completes the chemical process to form a battery, and some of it settles to its reservoir inboard of and below the inner circumference structural resistance barrier while the flywheel/battery is mechanically at rest; but is pumped outward and over (or through orifices in the electrolyte intermediate containment barrier to the outer circumference when the flywheel is spinning, and slowly drains back to the reservoir through the electrolyte return orifices in the electrolyte intermediate containment barrier as the flywheel/battery slows down.

The inertia management system consists of: framework to support the total propulsion, payload and passenger requirements; joints in the framework to allow independent (or reduced) dependence/interference with the other interacting forces; selectable means to actuate or modulate these interacting motions for safety and feasibility needs; a ball mounted end of the flywheel shaft; a radial bearing about the shaft beyond the fixed end which has the ball; at least a pair of actuators (or shock absorbers) spaced around the axis flywheel rotation at approximately 90 degrees to each other for acting to affect different directions of forces; a sub-carriage onto which the flywheel fixed end having the ball is mounted, which is somewhat directionally isolated from the frame of the E-V by springs and other ball pivot point as referenced in said U.S. Pat. No. 5,788,186.

Thus a basic object is to provide a compressed mechanical energy storage device plus a load decelerating apparatus for a variety of uses: To act as prime mover through an array of gears (or planetary gears if desired) and a flywheel (or flywheels) to drive a generator/alternator/ battery charger for local recharging of E-V batteries on the go and at a moderate rate to extend the range that the vehicle can travel.

A related object of the present invention is to provide a flywheel/battery that for short duty may be electrically connected in series with the main vehicle battery for hill climbing power etc. when the main battery bank voltage is depleted such that optimum drive motor full load voltage could not otherwise be obtained and/or to allow a rest period to be selected for a portion of the battery bank.

Another primary object of the present invention is to reduce the delay time required (that the E-V will have to be stopped i.e. travel time interrupted), to bring the battery to a useable state of charge.

Another secondary object of the present invention is to use my compressed energy recharging device to serve a dual purpose to provide a load decelerating apparatus (in one mode) that may selectively be deployed to move the point of impact further in front of the occupant safety/damage zone of the transported load or vehicle prior to and during onset of a collision to start the critical deceleration earlier so it will have a fraction more time to decelerate and (in the other mode) to use compressed energy to provide useful work in enhancing battery operability and service life.

Another basic object of the present invention is to provide a means for a retractable sliding contact group to get power from the conceptualized Inroute Charging Station, roadway coupling (such as a three phase, isolated from ground, power bus in the roadway at a time when such might be provided by the highway department, Department of Transportation; utility or some other commercial providers) while the E-V is in motion to drive the recharge tool motor and recharge the energy absorber to extend the range of E-V travel without stopping which does not risk damage to battery from sparking or improper rate of charge; and does not immediately affect the battery bank float voltage or the E-V drive motor speed.

A further object is to provide a retractable, shock resistant sliding contact means for providing power to charge the mechanical absorber device, that is retracted when not anticipating immediate use and to protect from road grime. A more basic object of the present invention is to provide a device that reduces undesirable load weight of the batteries on the E-V spring suspension.

A related object is to provide a carriage to convey the battery with the E-V, but not integrally to the vehicle frame structure in terms of directional inertia (acting as part of an inertia management system).

A related object is to provide a flywheel shaft pivoting alignment actuator(s) to act along with a resilient upper bearing mount, as part of a gyroscopic energy management system in the vehicle to reduce maneuverability drawbacks; or to induce dynamic effects for performance enhancement.

A related object of the invention to alleviate the undesired effects of the flywheel is to provide a loosely spring biased suspension controlling a sub-carriage onto which is mounted the flywheel in a manner such that the specific motions of the vehicle may be deviate somewhat from that of the vehicle to momentarily uncouple the gyroscopic undesired effects of the flywheel from the vehicle inertia for improved agility in a flywheel vehicle.

Another related object of the sub-carriage is to use the main batteries on the flywheel sub-carriage to act as ballast to stabilize the sub-carriage as the sub-carriage stabilizes the flywheel.

Another basic object of the invention is to simplify replacement of previously discharged, or otherwise unserviceable vehicle battery as a separable roll out replacement as a component.

A related object is to provide a quick disconnect for the battery power and mechanical termination.

An embodiment of the present invention is to use a specially styled rotating auxiliary battery as a flywheel to save weight and to be used in series with portion(s) of the main battery when beneficial for the main battery health or performance parameters in consideration, to help maintain acceptable electric vehicle performance through a greater percentage of the battery capacity.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is an elevation view of the necessary components of the E-V and block schematic representations of the in roadway recharge system, from the left side.

FIG. 2 is a diagram of the relative positions of FIGS. 3, 4, and 5 elevational views and of FIGS. 7, 8 and 9 plan views with front elevational view position of FIG. 11 shown also.

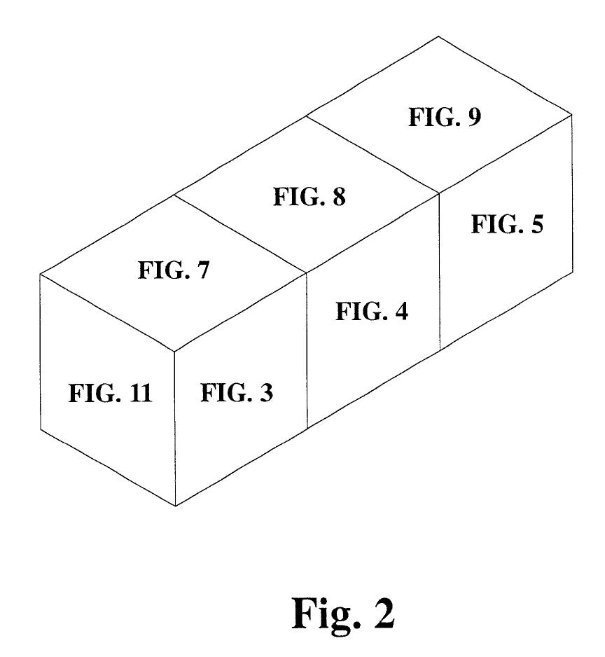

FIG. 3 is a front portion elevational left side view (with phantom lines for body and portions cut-away for clarity). Also shown are the locations of cross sectional cut away views for FIGS. 10, 11 and 12.

FIG. 4 is a side elevational view of the left center ⅓ portion of the invention with phantom lines for a body and parts cut-away for clarity (showing some of the retractable arm assembly, roadway bus cut-away, and secondary energy storage system.

FIG. 5 is an elevation view from the left side of the rear one-third of the present invention (with phantom lines depicting the cut-away body, and tires cut-away) to show possible flywheel/battery and main battery orientation. This view shows the location of viewpoint for FIG. 13.

FIG. 6 is a simplified plan view schematically showing the functional relationships of the energy conversion, storage and transfer components with details omitted or cut away for clarity.

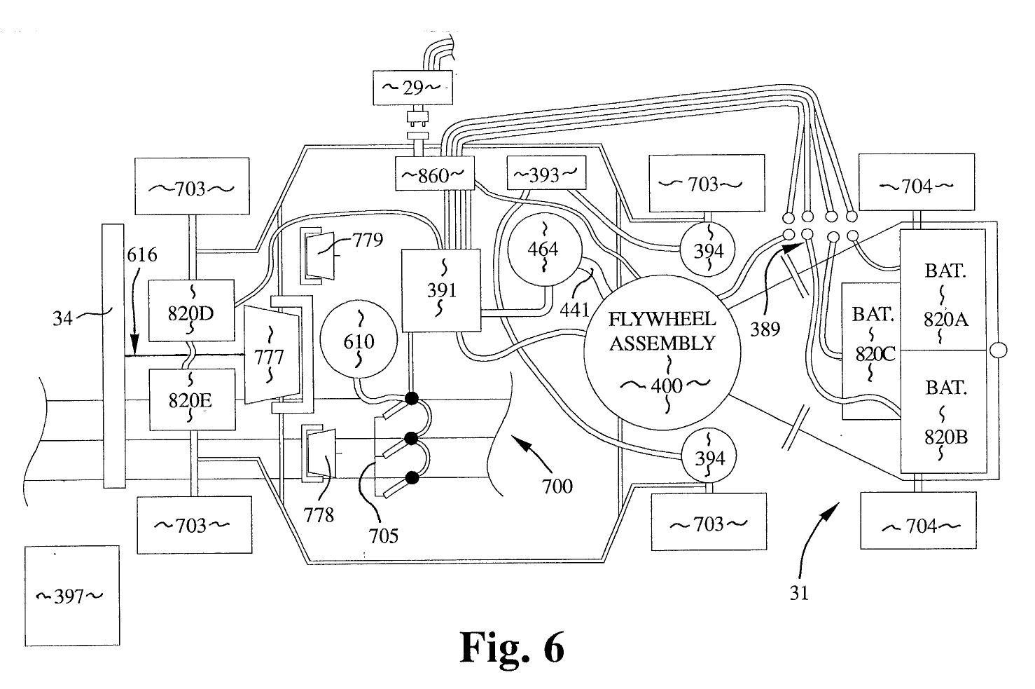

FIG. 7 is a plan view of the front one third view of the invention, with portions broken away, omitted or shown partially in section for clarity.

FIG. 8 is a plan view of the middle one third of a preferred means of locating additional storage devices with portions cut-away for clarity.

FIG. 9 is a plan view of the rear one third of the invention showing the sub-carriage means, with portions cut-away for clarity and the relative location of where FIG. 16 is to show.

FIG. 10 is a front sectional view of the primary energy storage system assembly showing notches in the incremental release devices.

FIG. 11 is a sectional view from the front of the automatic release mechanism (with front bumper omitted and some hardware scaled up for clarity).

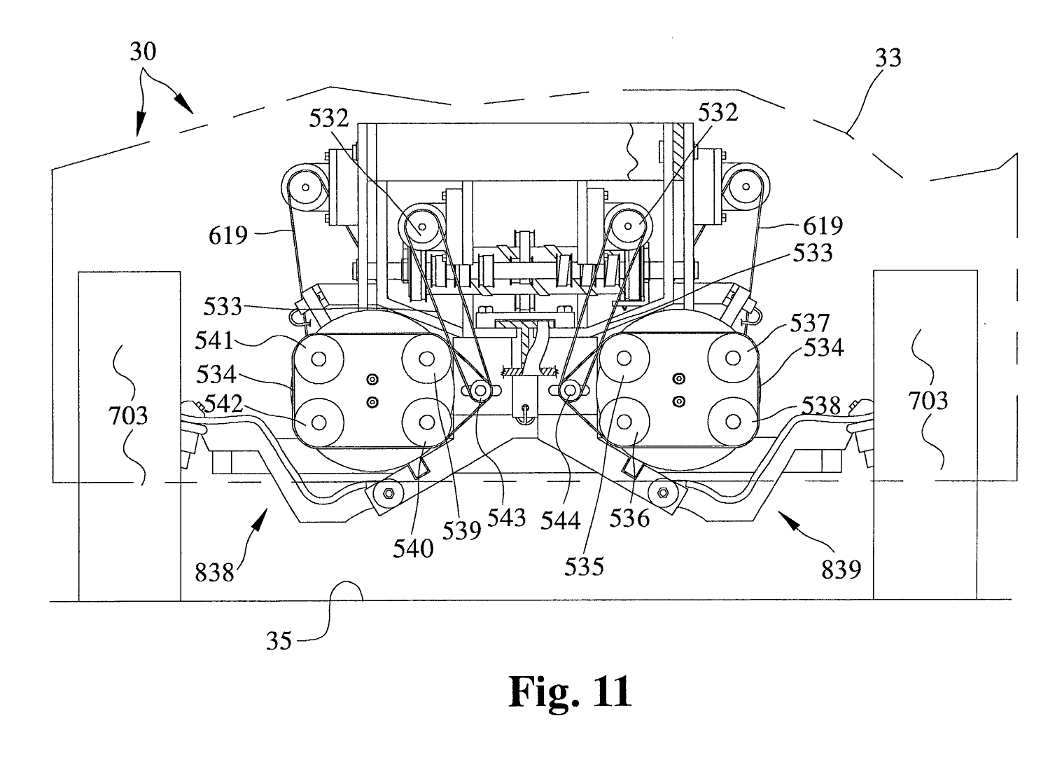

FIG. 12 is a sectional view from the rear of the primary energy storage system showing a contemplated recharge drive means on one side and a cut-away to show the mechanical linkage method on the other side.

FIG. 13 is a view from the bottom of the flywheel/battery bottom gear as indicated on FIG. #5.

FIG. 14 is a partially fragmented cut-away enlarged side view of the flywheel/battery assembly and associated peripherals (as indicated in FIG. #5 by the circle of phantom lines) with portions broken away or omitted for clarity.

FIG. 15 is an enlarged cutaway view of the flywheel/ battery pivot ball mount and the power take off gearing means.

FIG. 16 is a partially fragmented cut-away plan view of the flywheel/battery and actuators as indicated by circle in FIG. 9.

FIG. 17 is an enlarged cutaway view of the integral cells from the top showing plates (a reduced number of plates is shown for clarity).

FIG. 18 is an enlarged exploded isometric view of the energy storage device, the automatic release/restraint assembly; and charging bolt.

FIG. 19 is a flow chart view, of the preferred embodiment of the invention in conjunction with functional block diagram showing a diagram of the major components into system categories.

### DETAILED DESCRIPTION

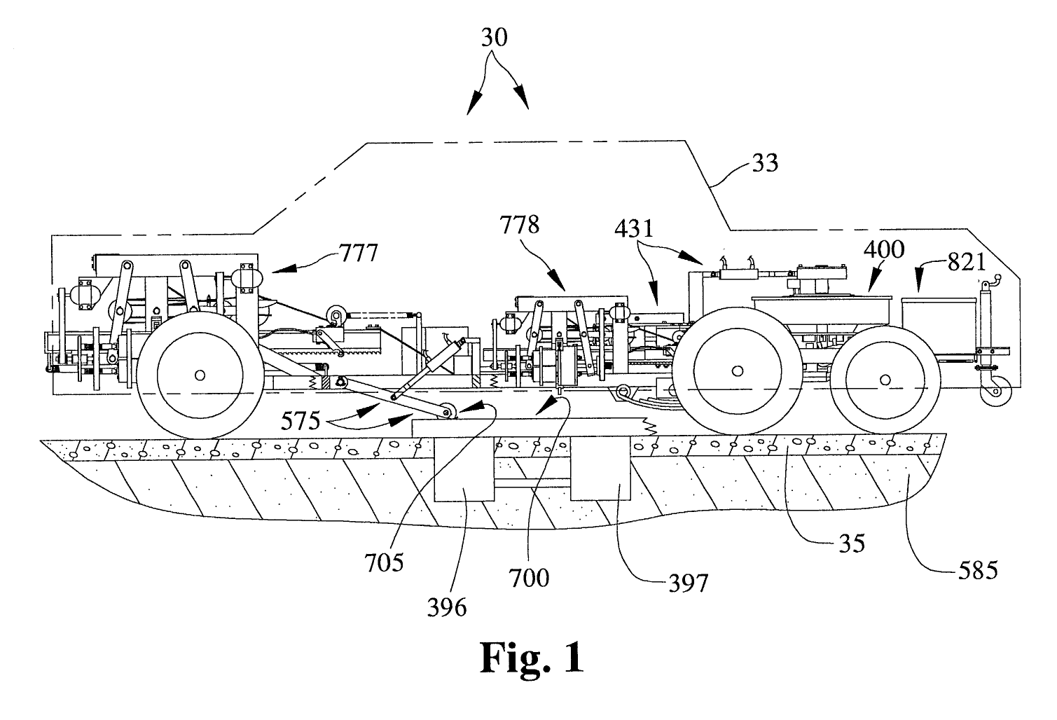

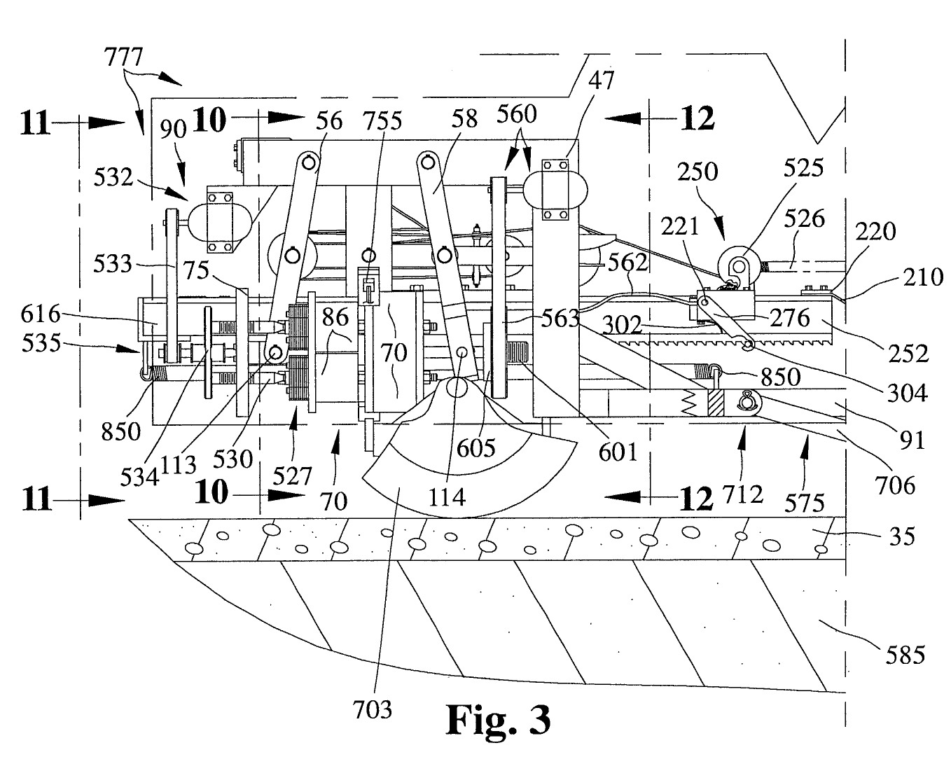

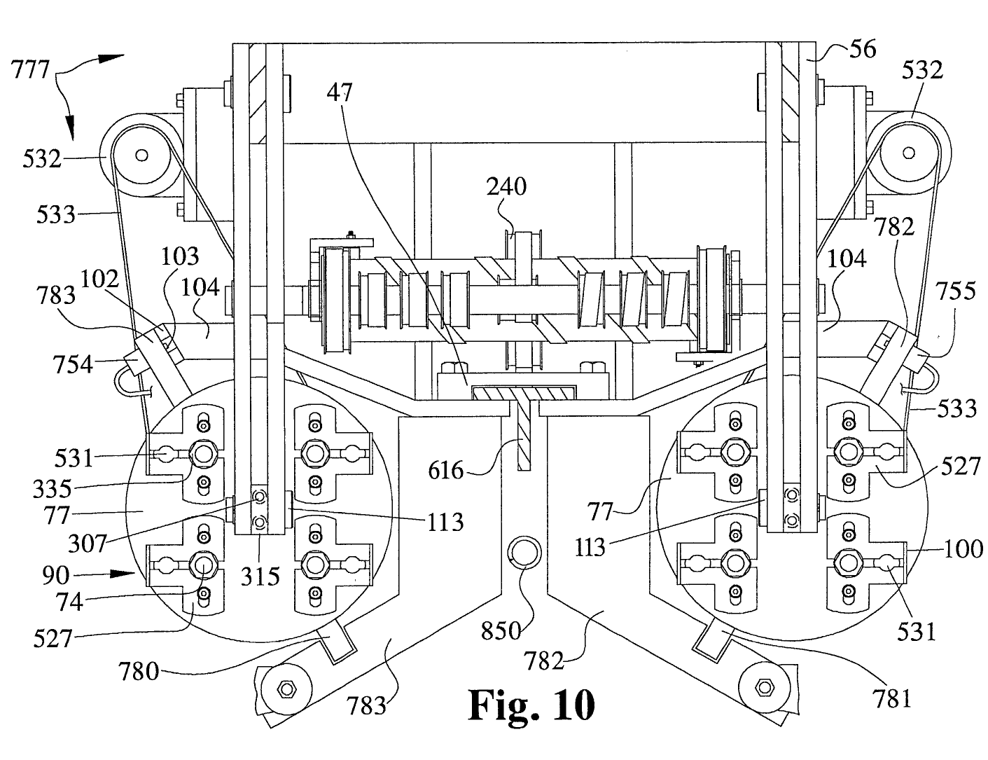

Referring more specifically to the drawings, the E-V Range Extender recharge-on-the-go apparatus is broadly designated by the number 20 (FIG. 1). With attention initially directed to an impact absorbing apparatus referencing my U.S. Pat. No. 5,947,538 IMPACT ABSORBING APPARATUS adapted to be mounted and used as a primary mechanical stored energy system 777 and secondary mechanical stored energy systems 778 and 779, for left and right respectively, for an E-V 30 is shown. The apparatus 20 comprises multiple custom mounting means 50, 51, 52 that is fitted to the perimeter of an E-V 30 (or in higher power applications, the custom mounting means can be mounted at roof and serve also as a passenger safety roll cage). A rigid chassis 91 is affixed to (or part of) the custom mounting means 50. A slide assembly 47 (FIGS. 10 & 12) is suspended from the chassis 91 and slidably captivates a longitudinally displaceable ram assembly 616 (FIGS. 3 & 10). The ram assembly comprises a power drive ram return spring 850 (FIG. 3) and an impact absorbing bumper 34. The impact absorbing bumper 34 is exposed for contact at the front of the E-V 30 and is securely mounted to the ram 616.

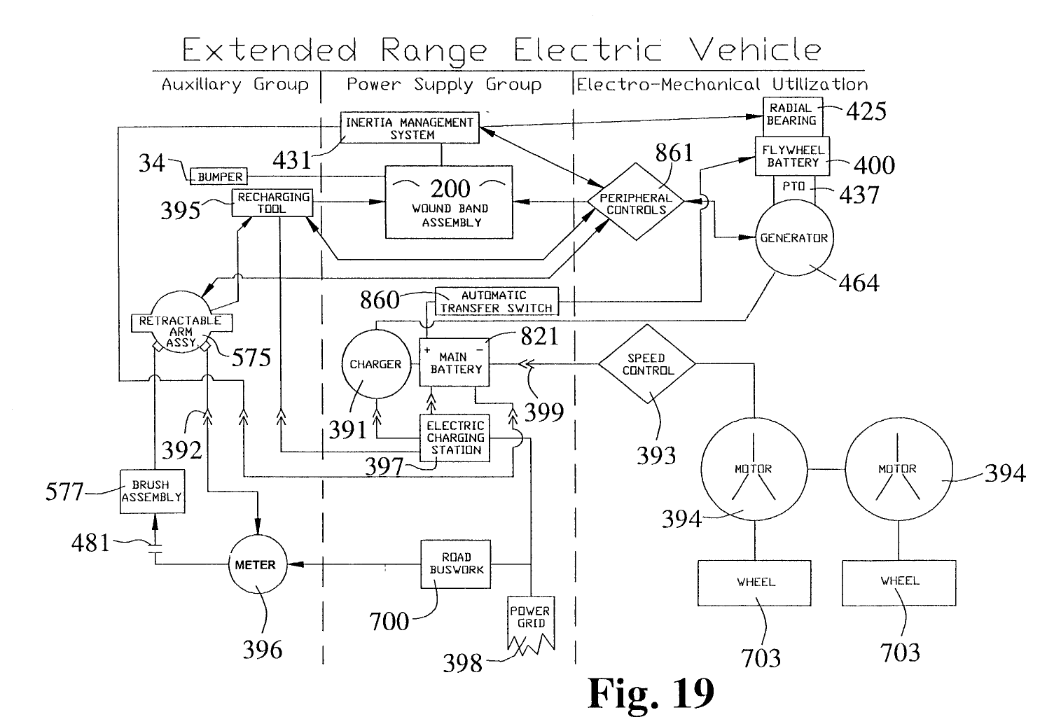

A wound band assembly 200 (FIG. 19) is fitted to the chassis 91 and is dynamically coupled to the slide assembly 47. Lever means 56, 58, (FIG. 3) hang downwardly at each side of the chassis 91, each lever means having top ends pivotally coupled to the chassis 91, intermediate portions adapted to be pivotally coupled to the wound band assembly 200, and end portions hanging downwardly. Compression absorber means 70 (FIG. 3) are disposed at each side of the chassis 91 and are pivotally connected to and between the end portions of the lever means. The lever means provide a mechanical advantage reduction in conjunction with the band assembly, as the shock absorbers have only a limited range of deflection in which energy may be dampened. In a contemplated embodiment the wound band assembly 200 may be located on the lever ends and the compression absorber means 70 located at the present wound band location to put the wound band below the floor of the E-V for space savings.

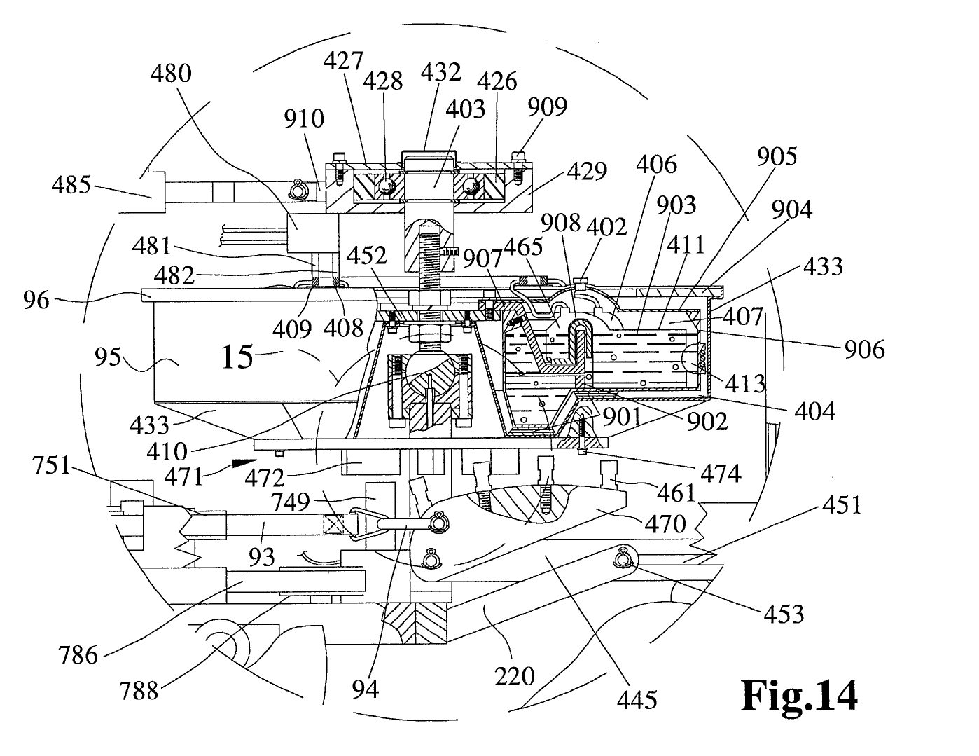

The chassis 91 (FIGS. 3-5) is generally rectangular comprising a pair of parallel sides 54 and a front 53 and a rear 52. The rear 52 is fabricated by attachment mount 101 to allow the attachment of the flywheel/battery ball and socket support 410 (FIG. 14). The kick-start brace 220 is secured to the rear 52 of the chassis 91 by welding mount 221. The flywheel/battery radial bearing assembly 425 (FIG. 14) is mounted on upper end of shaft between positioning lock rings. The bearing 428 has its outter diameter resting snug inside an elastic damping material 426 and is protected by a cover 429. (A standard means for greasing is contemplated but not shown).

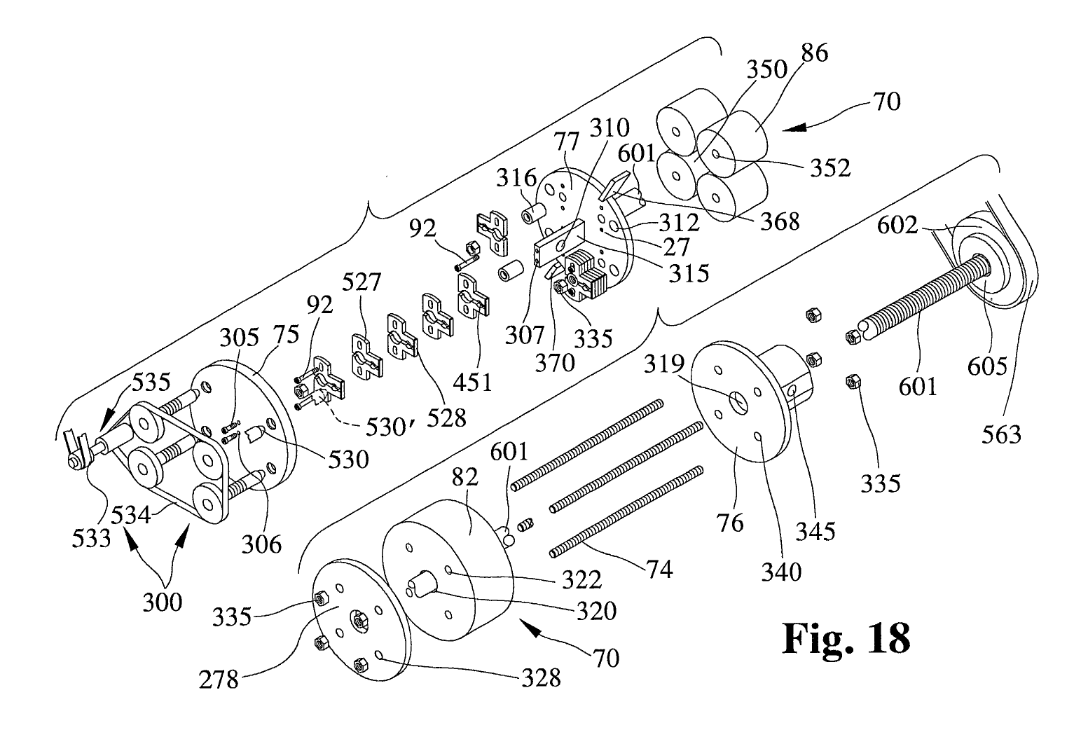

Captured and pinned at the lower end hole terminals 113 of the lever means 56-63 are the progressive compression absorber assemblies 70 with automatic release means 90 (FIG. 3). The progressive compression absorber assembly 70 is shown in greater detail (FIG. 18). Indexed by the shoulder bolts 92 are the release means 90 (FIG. 10) such that half of the automatic release assembly is on one side and the other half is on the other.

These absorber aligning bolts 74 (FIG. 18) are used to maintain the compression load on the absorber 70. The absorber is brought to desired tension by tightening the compression charging bolt 601 (FIG. 3) with a recharging tool wrench 602 (Spring Recharge tool: The Torque Machine

Hytorc®, Division Unex Corp; 333 Rte 17 North,

Mahwah, N.J. 07430

(or) ALDON Gatemaster II Assembly® “Torque Wrench” with: Rigid electric pipe threader power assist) until setpoint is indicated by the primary and/or secondary mechanical stored energy system arms torque/limit switches 754 through 769 respectively. Then the recharging tool wrench 602 is backed out of the way according to circuit logic and the locking means maintains the compression force. The locking means 90 (FIG. 10) is then rotated enough for the shoulder bolts 92 to align with the shoulder bolt assembly orifices 27.

The shoulder bolts 92 (FIG. 18) are sized to tighten snug to the oval mounting slots 306 centered vertically in face 308 but not compressing the upper catch 94 (FIG. 10) and the lower catch 96 respectively to allow freedom of movement to engage the area between the bolt adjustment 278 and the outboard plates 76 as the progressive compression absorber assembly 70 is compressed. To assure that the upper catches 94 and the lower catches 96 respectively engage when the progressive compression absorber assembly is compressed the engagement springs 100 (FIG. 10) are attached, stretched at back 316 along the opposite edge from the absorber aligning bolt to form the locking means 90 (FIG. 10). An identical/matched locking means is similarly mounted for each stacked portion of the systems 777-779.

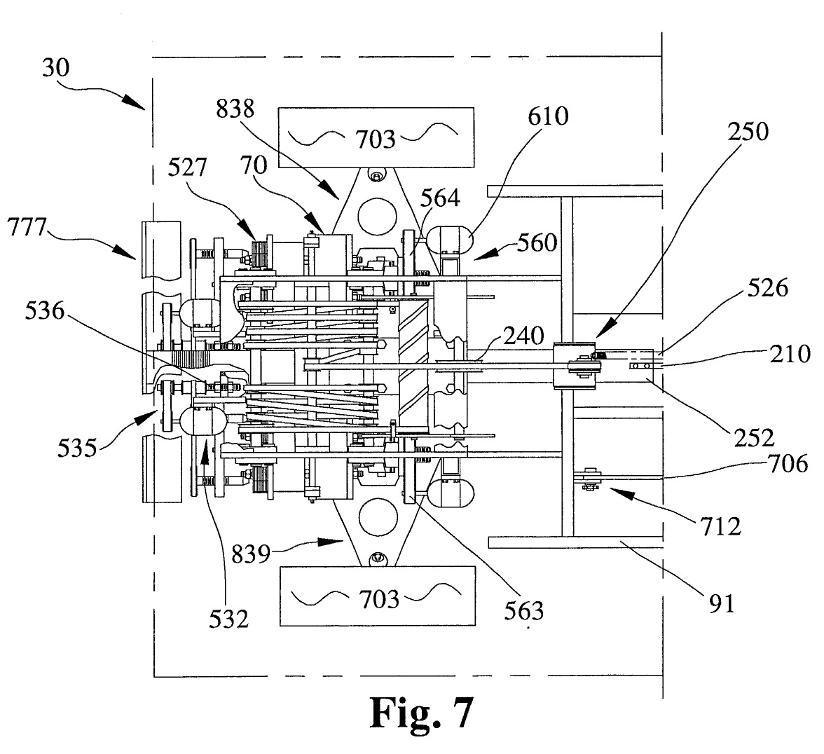

The wound band assembly 200 (FIG. 19) is a special block and tackle device to transfer the compressed energy load from the systems 777-779 through a ratio to increase the speed and distance that the systems 777-779 would be able to use the energy to initiate surge drive motion to the flywheel 400 (FIG. 1). This wound band assembly 200 has an elongated band 210 (FIGS. 7 & 8) that attaches chassis 91 by the end plate 220. Band 210 then progresses over guide pulley 240 (FIG. 7) before going to the end 250 where it is secured to the springed ratchet winch 525 (FIG. 3). The springed ratchet winch 525 is mechanically linked to the ram end 252 by spring-loaded shackle dog assembly 256 with tangs 276 and mounting hardware 221.

The ram slide assembly 47 slidably contains ram 36 under the wound band assembly 200. The positioning spring 850 works in conjunction with spring 302 and saw tooth engagement means 304 (FIG. 3) to assure that any loose protrusion of the ram and bumper is minimal and that slack in the wound band will be retracted by the springed ratchet winch 525 containing the spring loaded shackle dog is mechanically engaged with the saw tooth engagement means before the automatic release assembly catch 527 is released.

The automatic release assembly catch 527 is released by the offset cone-tipped camshaft 530 as the offset cone-tipped camshaft is advanced into a notch 531 (FIG. 10) between the upper and lower portions of the automatic release assembly. The offset cone-tipped camshaft is selectively driven on demand by a auxiliary powered means 532 and a power transfer means (schematically represented here) as the path of a chain 533.

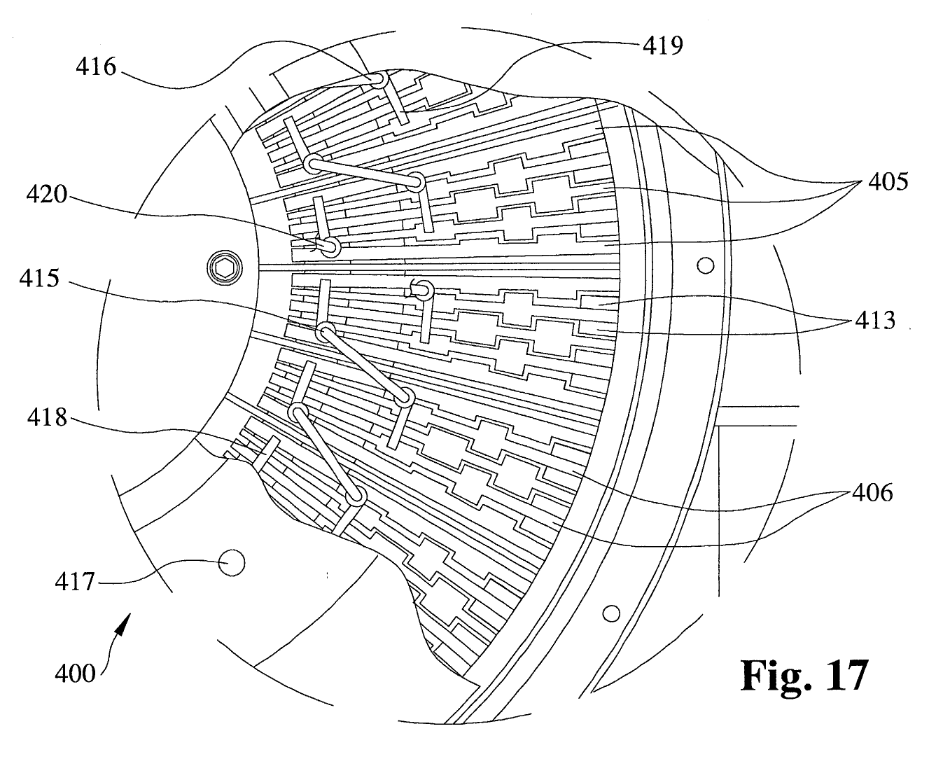

Now referring to FIG. 17, the components of a battery 400 are housed in the flywheel container 433. The positive plates 405 and negative plates 406 and separated by torque separators 413. The positive and negative plate connectors 418 and 419 respectively are to connect the plates of the same polarity of each specific cell in parallel. The cells are connected in series in a bank with the most negative− and the most positive+ lead 420 going out to connect to the slip ring 408 and the negative to 409.

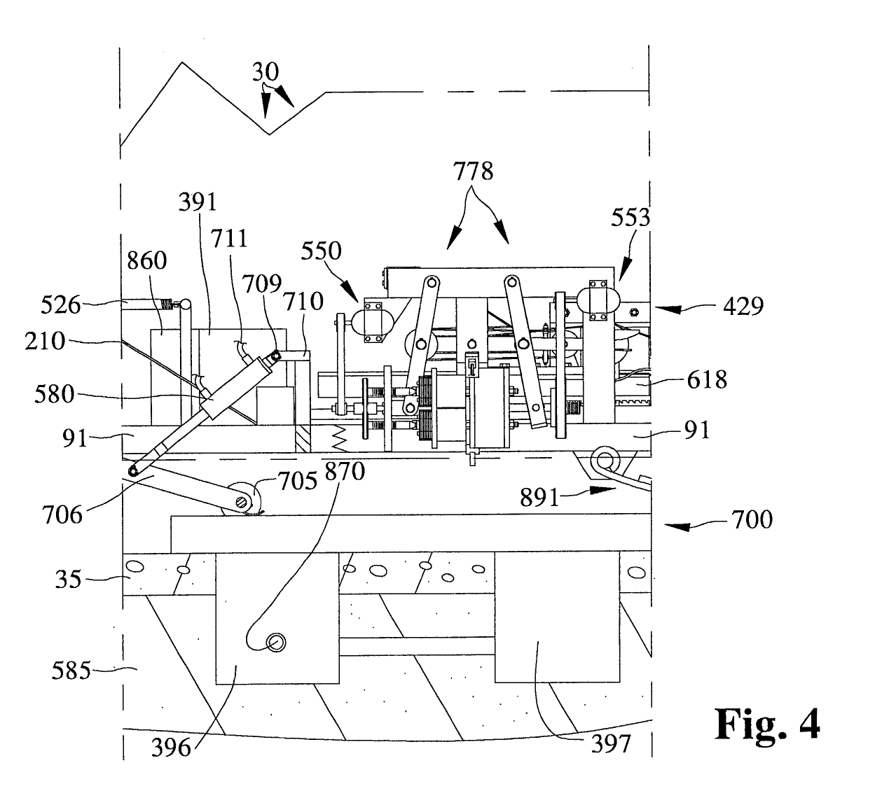

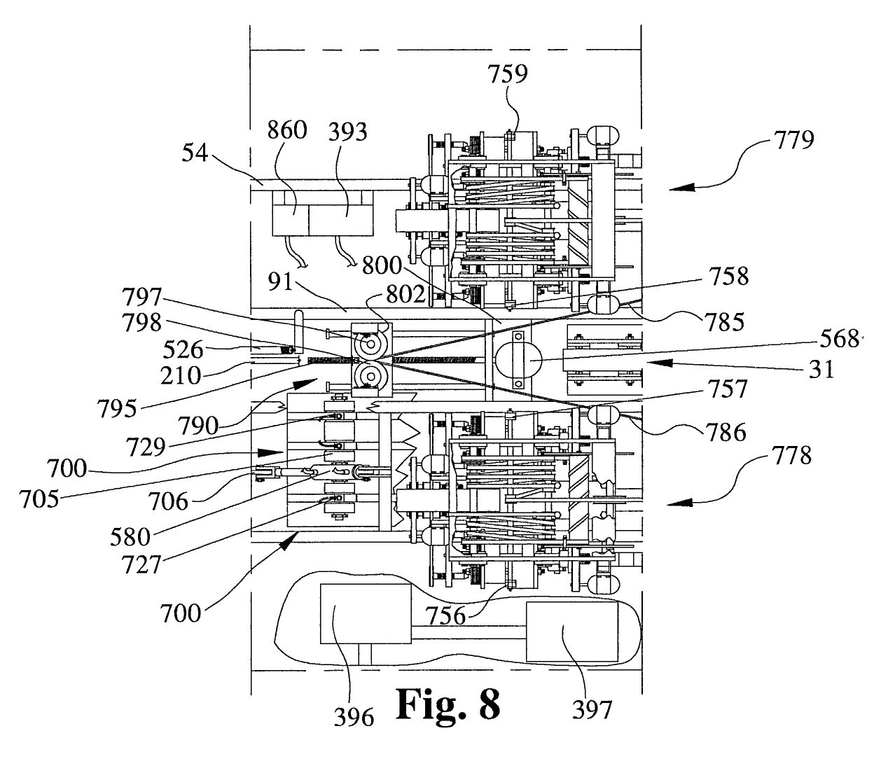

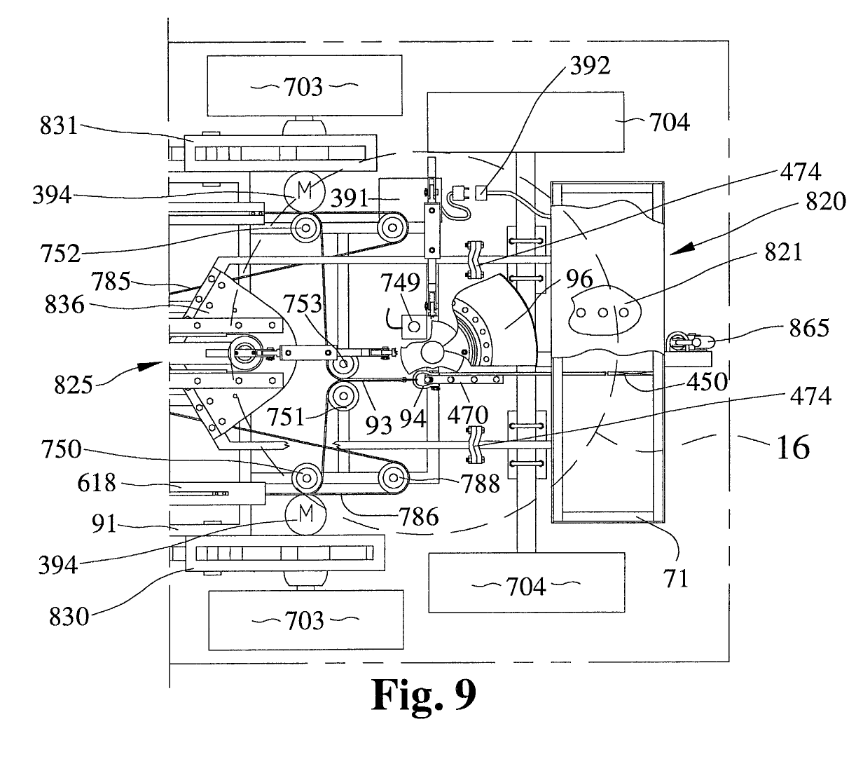

The components of the Electric Vehicle Range Extender apparatus 20 are normally spaced near the chassis 91 (FIGS. 3, 4 & 5) of the E-V 30. The primary ram 616 is ideally down the longitudinal center of the E-V 30 at approximate bumper height; the absorbers 70 are located on each side, of the wound band described in the IMPACT ABSORBING APPARATUS patent; the battery carrier 820 is trailing from a pivoting column assembly 825 (FIG. 9) preferably located forward of the rear wheels with the retractable sliding contact group assembly 705 (FIG. 8) ideally in front of that. An absorbing front bumper 34 is mounted perpendicular to ram 616 to allow the necessary clearance with the E-V front end 40.

Ram 616 extends from the front bumper to the rear of the spatial area between the absorber assemblies (multiple secondary energy absorber assemblies 778 and 779 are contemplated, as space permits and total energy requirements grow). The bumper 34 is supported by and gets its crashworthiness from the ram 616 (FIG. 3). The ram is oriented in a longitudinal direction along the approximate center of vehicle except when more than one unit is required; and/or when the particular application has this space already allocated to other uses and more than one is used to compromise for available space. The ram 616 is slidibly mounted to the bumper 34 and to the spring loaded shackle dog assembly 250 (FIG. 7) to assure that the dimensional requirements of the ram protrusion standards are met and that tension on the wound band assembly 200 is maintained a ram mounted spring 850 will disengage the dog assembly 304 while unloaded to allow the bumper to be pulled inward by spring 850 so bumper won't continue to stick out too far.

### OPERATION

The operation of my Electric Vehicle Range Extender can best be seen in (FIG. 1). The compressed absorber number 70 is compressed by the compression charging bolt 601 and is also shown in the charging position.

Normally, the roadbed mounted power buswork 700 supplies power from a utility distribution grid (not shown but assumed available). This power is brought onboard the vehicle through the power contacts and hardware assemblies 725, 727, and 729 so that it will be available to energize the recharging tool 395 which is typical of a commercial-off-the-shelf gear drive motor. This motor 610/recharging tool converts the power from the distribution grid to mechanical motion with a gear reduction sufficient to turn the recharging tool socket wrench 602 a power transmission link (i.e. nut) between the mechanical drive means 619 and the charging bolt 601.

The bolt threads into the recharging tool socket wrench 602 to cause the compression of the absorber. The thrust resistant socket assembly with thrust washer 605 allows the rotation between the wrench 602 and the bolt 601 which is a part of plate 77 and has reaction arms 368 and 370 to resist the torque of the wrench 602 on the bolt 601; and the assembly 605 accommodates the axial pressure of compression due to its threaded position.

The primary ram 616 is shown in a partially compression location. Similarly, the visible leg links for support to absorber assembly numbers 56, 58 are shown moved in response to compression tension on the progressive absorber assembly apparatus. For clarity of the drawing the small deviation of absorbers were not shown (but was explained more fully in my referenced U.S. Pat. No. 5,947,538 IMPACT ABSORBING APPARATUS).

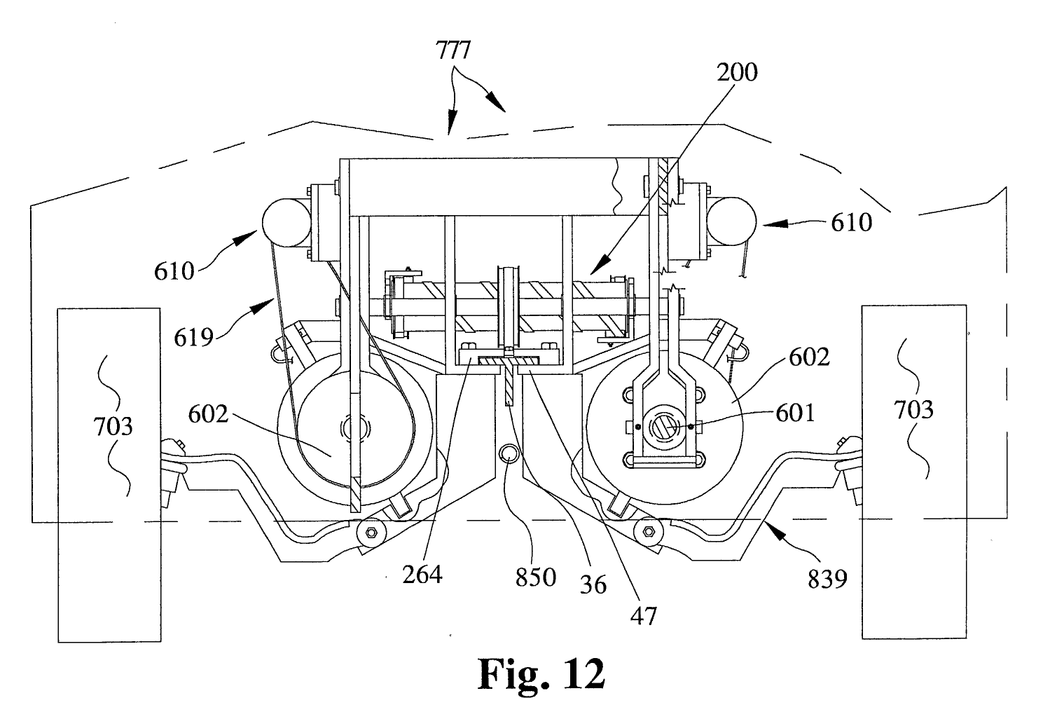

As the compression charging bolt 601 (FIG. 18) is tightened by the recharging tool wrench 602 and thrust resistant assembly with thrust washer 605 captured between head of compression charging bolt 601 and absorber collar by charging motor 610 (FIG. 12). The torque of the charging tool is countered by reactive arms 782 & 783 and stop bars 104 (FIG. 10). Ram 616 is pulled inward by the ram return spring 850 and slides, while contained by the ram slide assembly 47, so that the elongated band 210 of the wound band assembly 200 is slacked. The slack of band 210 causes the winch assembly 525 to wind to compensate for the reduced distance required by the wound band between pulley axles 285 and 284 (ref. FIG. 7 of IMPACT ABSORBING APPARATUS patent) to decrease pulling the lever arms 56, 58 together thereby compressing the progressive absorber 70 from both directions. The ram track assembly 47 (FIG. 10) maintains and directs the ram's 616 travel response.

As compression occurs, absorber aligning bolts 74 become slack. Then, any further compression adds more slack between the automatic release assembly 90 and the progressive absorber pre-load plate number 76 until the support of the adjustment tool 278 (FIG. 10) is over come and the locking means 90 engage by clamping the absorber tensioning bolts 74 (FIG. 18) inboard of the adjusting tool.

The winch assembly 525 engages sawtooth gear 304 in response to the forward movement of the ram 616 during spring return. The dog assembly 525 is in one direction slidibly mounted to ram 616 with spring 302 to allow one way movement of ram 616. The winch assembly 525 is adapted to lock in the depression 306 of the sawtooth 304 thereby further restricting any lost energy of the ram 616 when the compressed progressive absorber assembly is released. (Contemplated is an actuator device to adjust the ram position within more attractive parameters and to allow ram to be automatically extended to the maximum just prior to frontal impact for added travel distance and increased safety).

When selected manually or upon receipt of a contemplated signal (such as “Drop in Loaded Battery Voltage” or “Power Demand High” and “Zero Speed Flywheel”—for the secondary mechanical stored energy systems or “Secondary Storage Depleted”) is received, then, the Auxiliary Powered Means 532 is energized to cause rotation of the idler gearing 543 which in turn rotates the release mechanism sprockets 535-542. The automatic release assembly catches 527 are mounted in similar stacks onto the release assembly bracket 315. As the sprockets 535-542 turn, the offset cone-tipped camshafts 530 is threaded axially into the notch 531. This spreads the first catch halves apart while flexing the bent leaf spring 528 on the respective catches.

The extra clearance provided by the spread out halves allows the restraint collar 316 to slip one increment down the stack to another catch where it rests until the offset cone-tipped camshaft spreads another catch out of the way on the next subsequent power release. This allows the compressed absorber assemblies to expand which moves the lever means to pivot slightly, which controls the distance between the pulleys and because of the mechanical advantage of the block and tackle, the resulting movement is faster and further.

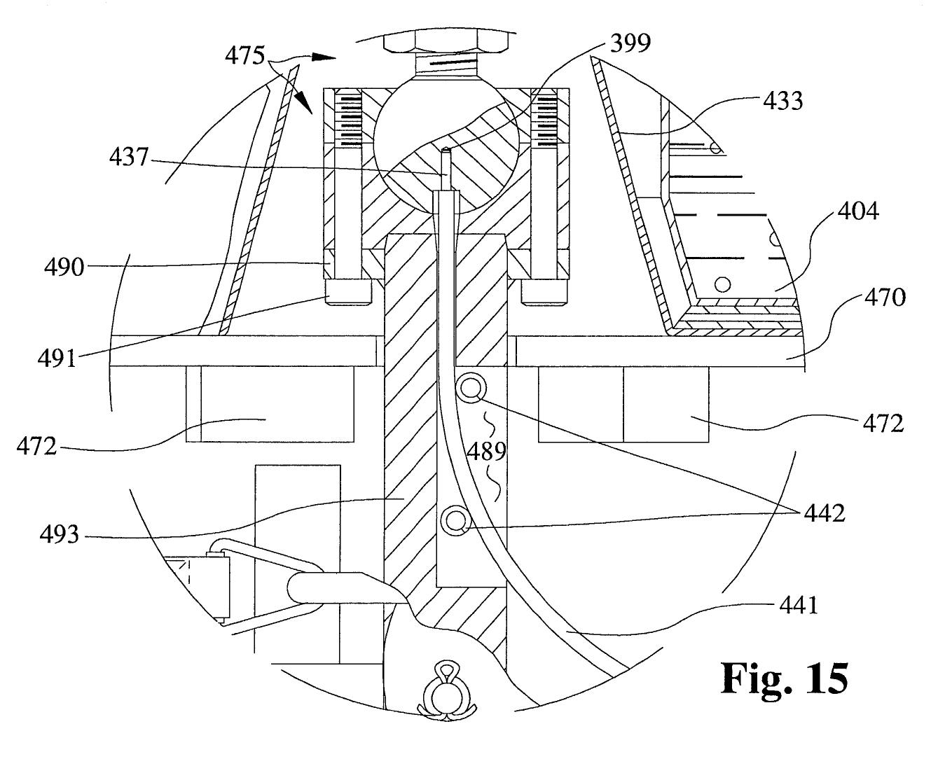

The secondary rams when incrementally released, slam forward and toggles the flywheel bottom gear striker lever 471 (FIG. 15) to spin the flywheel as the dogged cam driver 445 (FIG. 14) engages the flywheel gear 471 on power stroke. The flywheel/battery 400 then in motion, continues to spin and set in motion the flywheel/battery drive gear 437 and an array of gears to adapt the rotation speed with generator/alternator 464 (FIG. 19) mechanical power requirement. The rotating generator/alternator then supplies recharging current to the main battery portions 821A-E via battery charging circuit 391 (FIGS. 4 & 19). Battery Charger:

Model BC6600 6.6 kW Charger

Solectria® Corporation; 33 Industrial Way

Wilmington, Mass. 01887-3433 (or similar for example)

Also, an Automatic Transfer Switch:

ASCO Power Technologies®, LP; Florham Park, N.J. 07932, (or similar for example) sectionalizes one or more portions of the main battery and replace with the equivalent amount of battery capacity from the flywheel source, for a short time and then, restore the first and sectionalize another out of service until all main battery portions have had a period of continuous duty interrupted.

When the Flywheel has lost a substantial amount of its power, a switching means, such as a centrifugal switch or zero speed proximity switch 749 (FIG. 9) or the like works in conjunction with a selectable switch (not shown), which closes to start the auxiliary powered means to drive the cam to initiate the release the next increment of power, as stated above (unless the vehicle is not moving, at which time the permissives are locked out by a lockout switch (not shown). (A contemplated safety interlock “lockout” switch, requiring that the vehicle be moving, is contemplated to prevent the release of the next increment of power while the vehicle is at rest so the bumper won't jump out and hit a pedestrian while the E-V is waiting at a crosswalk).

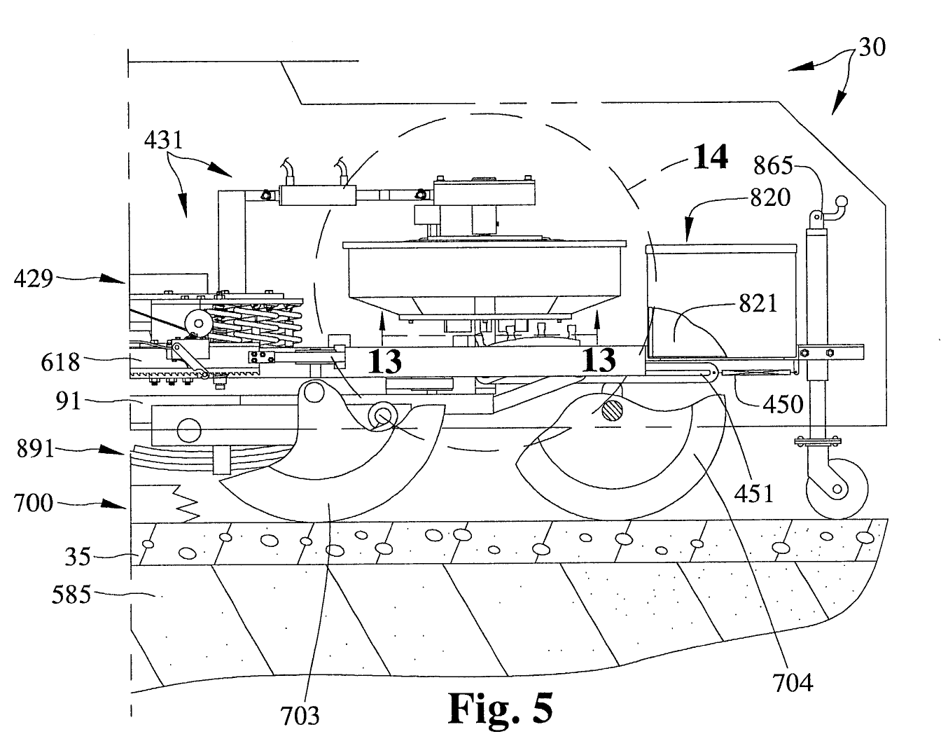

Since the flywheel would otherwise cause objectionable gyroscopic problems related to the maneuverability of the E-V if it were solidly mounted; the flywheel assembly 400 which is spinning about a vertical axis supported by a ball and socket assembly 475 (FIG. 15) with PTO beginning at the center of the ball. The flywheel/battery spins, expending its energy through drive gear (or constant velocity joint) spline 437 and PTO assembly 441 to the generator/alternator 464 to feed power to the battery charger 391. The battery charger charges the main battery 821 (FIG. 5) to power the E-V drive motor(s) 394 (FIG. 19). (Electric motors such as Solectria® or Unique Mobility® motors).

The pivoting mechanical portions of the retracting sliding contact group are similar to that described in the referenced patent Helicopter External Load Suspending Apparatus U.S. Pat. No. 5,788,186. Also the suspension for the sub-carriage is pivotally mounted on a suspension similar to that shown in the referenced patent Helicopter External Load Suspending Apparatus to allow better management of the flywheel inertia and gyroscopic problems by maintaining a separate traction surface on the roadway flexible from the pulls of the flywheel axis. (Contemplated other uses of the said patent for this are: user friendly, tool accommodating quick disconnects for the main battery power leads to allow quick disconnect and still maintain a constant minimum contact pressure; and as a width articulated suspension for a set of wheels for higher mobility applications).

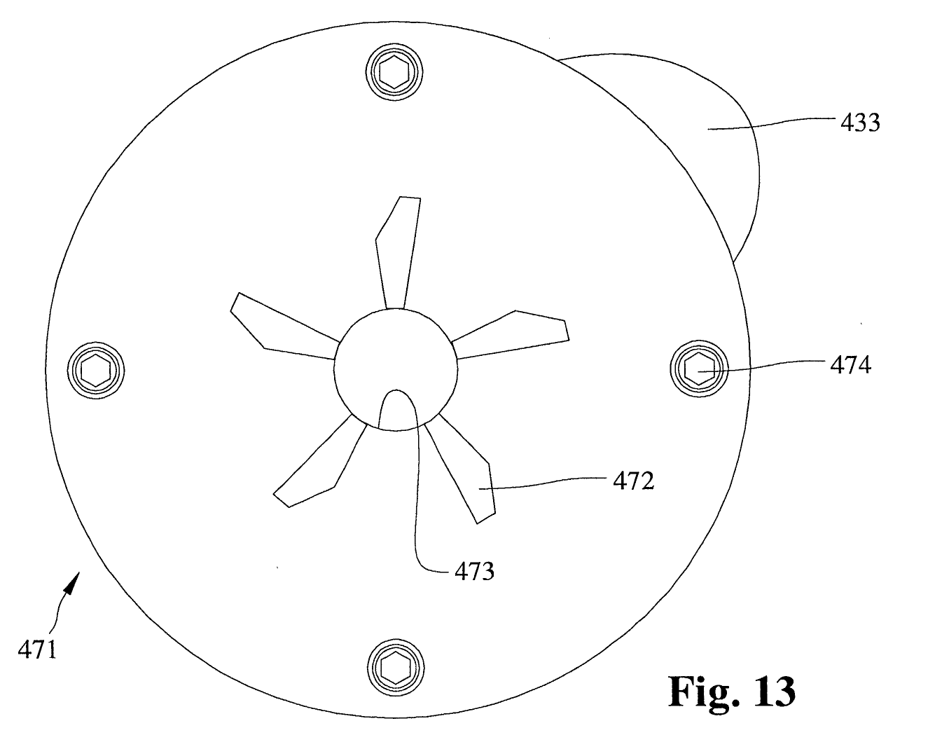

The flywheel/battery 400 having a spherical ball and socket support assembly 475 (FIG. 15) with bolts 491 through a flange 490 welded to the flywheel support tower, defining the pivot point of the stationary end of the rotational axis 399, and a radial bearing 428 with elastic material 426 on the leverage end 403. The flywheel is set into motion by the striking of the bottom drive gear 471 (FIG. 13) and as the flywheel continues to rotate the power take off assembly 441 transmits the motion to the battery charger 464. The elastic material 426 tends to absorb vibrations due to any electrolyte unbalance and some small transient conditions.

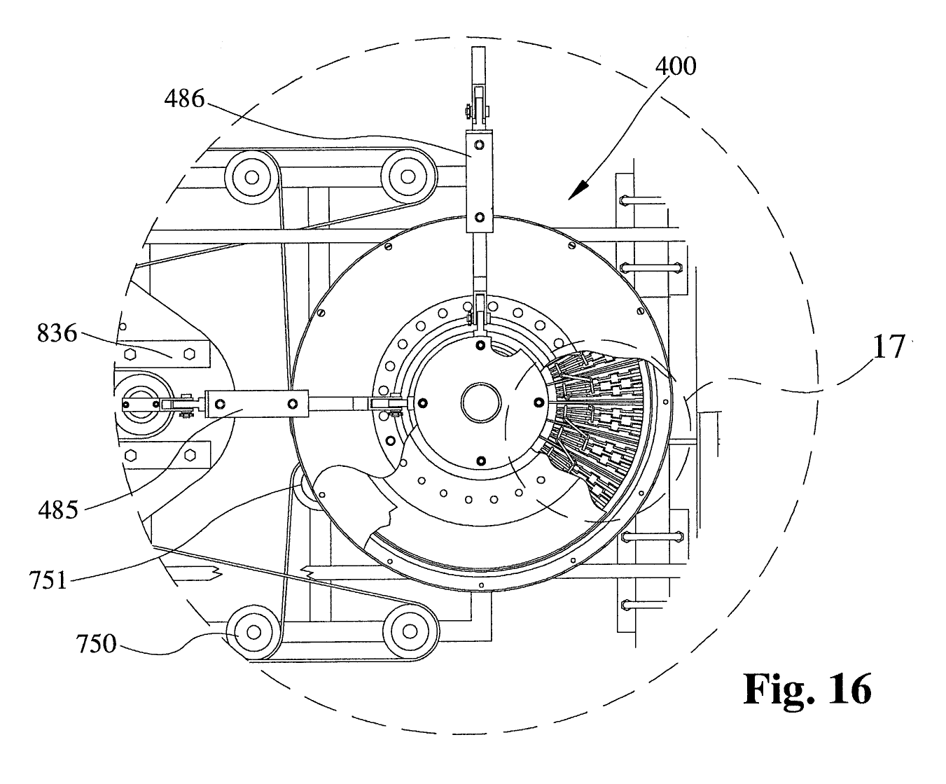

The longitudinal and transverse actuators 485, 486 (FIG. 16) respectively provide an active response to larger transient conditions such as encountered with sharp turns and hills while the flywheel is in motion, and is contemplated to provide benefits for predicted high performance handling enhancements receiving input from engageable road surface traction sensors, loss of spring load on suspension, and sharp turn in the prohibited direction of the steering wheel, and correctable body roll.

From the foregoing, it will be seen that this invention is one well adapted to obtain all the ends and objects herein set forth, together with other advantages which are inherent to the structure.

It will be understood that certain features and sub-combinations are of utility and may be employed without reference to other features and sub-combinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

What is claimed is:

1. An electric vehicle apparatus for compressed energy absorbing, energy storage, conversion, flywheel energy storage and release, having gyroscopic force management means, said apparatus comprising:
a flywheel comprised of electrical battery;
a chassis adapted to be attached to a vehicle;
a sub-carriage attached to the electric vehicle chassis;
an impact absorbing bumper exposed for contact;
a displaceable ram projecting from said bumper and slidably captivated by said chassis;
a wound band assembly capable of being activated by said ram and also capable of being activated by mechanically charging via utility power, the release of energy from the energy absorbers;
a lever means driven by said wound band assembly capable of driving the wound band and ram in the energy release mode; and, shock absorber means activated by said lever means;
whereby, when said bumper is forcibly impacted, said ram is displaced longitudinally thereby tightening the wound band assembly and causing the levers to compress the shock absorber means; so, also with charging by electro-mechanical means or pneumatic power driven tools;
A compressed energy device that comprises all the claims 1 through 18 of the referenced pending patent IMPACT ABSORBING APPARATUS;
wherein said wound band assembly comprises a plurality of rotatable drums and an elongated, resilient band entrained about the drums and comprising a rear end fixedly terminating at the chassis and a front end terminating at said ram;
Wherein said lever means comprises first and second pairs of levers at each side of said chassis, each lever having top ends pivotally coupled to said chassis, intermediate portions pivotally coupled to drums of said wound band assembly, and end portions coupled to said shock absorber means, being an energy storage means,
Wherein said energy storage means comprise:
a rigid front plate;
a rigid intermediate plate;
a plurality of spaced apart resilient absorbers captivated between said front and intermediate plates;
a rear plate; and,
a single large diameter absorber sandwiched between said rear plate and said intermediate plate,
Wherein said energy storage means further comprises:
a first rigid, threaded shaft means secured to said front plate and extending towards and through said rearward plate;
a second rigid, threaded shaft means secured to said rear plate and extending towards and through said front plate;
a first locking means on said front plate attached to the remote ends of said second shaft means;
a second locking means on said rear plate attached to the remote ends of said first shaft means;
whereby when the shock absorber means is compressed, and the remote ends of each shaft means are deflected away as the front plate and rear plates are compressed together, the shaft means are clamped by the first or second locking means to prevent the shock absorber means from uncompressing after the initial compression;
wherein said first and second locking means comprises a stack of laminations penetrated by said first and second shaft means and a fastener terminating said first and second shaft means flushly adjacent each stack,
Wherein each lamination comprises a pair of opposed catches and spring means yieldably biasing said catches towards the first and second shaft means, such that, when the front and rear plates are compressed together, the exposed threaded shafts of the first and second shaft means are forcibly captivated by said catches to prevent subsequent uncompressing and rebound;
wherein said wound band assembly comprises a plurality of rotatable drums and an elongated, resilient band entrained about the drums and comprising a rear end fixedly terminating at the chassis and a front end terminating at said ram;
a single large diameter energy absorber sandwiched between said rear plate and said intermediate plate.

2. The apparatus defined in claim 1 wherein said compressed energy absorber means further comprises:
a first rigid, threaded shaft means secured to said front plate and extending towards and through said rearward plate;
a second rigid, threaded shaft means secured to said front plate and extending towards and through said rear plate;
a first locking means on said rear plate attached to the remote ends of said first shaft means;
a second locking means on said rear plate attached to the remote ends of said second shaft means;
a number of threaded shaft means secured to said front plate and extending towards and through said rearward plate;
whereby when the compressed energy absorber means is compressed, and the rear remote end of each shaft means is deflected away as the front plate and rear plates are compressed together, the shaft means are clamped by the first or second or a number of other locking means to prevent the compressed energy absorber means from decompressing after the initial compression;
and to allow the incremental release of the compressed state to perform work, such as setting a flywheel into motion.

3. The apparatus as defined in claim 2 wherein said compressed energy absorber comprises a selective incremental release system of drive means, power path, screw, cam or trigger actuator means capable of releasing fractional portions of the compressed energy from the said compressed energy absorber(s) to repeatedly set a flywheel into motion to drive an electrical generator.

4. The apparatus as defined in claim 3 wherein said compressed energy absorber comprises a means to maintain the compressed energy absorber in the compressed state with the compression charging nut backed outboard, the means for preventing the uncontrolled rebound of said compressed energy absorber being the locking means;
a ratcheting dog stop to resist the bumper and ram rebounding outward beyond a specific distance, (unless over-ridden by an impending collision signal).

5. The apparatus as defined in claim 4 wherein said moveable end wound band attachment comprises a springed ratchet winch that removes slack from wound band means at various other incremental stages of uncompression.

6. The apparatus as defined in claim 5 wherein said moveable end wound band attachment comprises a ratcheting dog which engages said saw teeth on the ram at various amounts of remaining energy storage to transport the torque from the motion of the ram to a toggled lever-gear to set in motion other apparatus such as secondary energy conversion devices or a flywheel.

7. The apparatus as defined in claim 6 wherein said toggled lever-gear comprises a multi-radiused curvature of gear teeth which engage the drive gear of the flywheel to ultimately set the flywheel into motion whether from a unit having only a primary mechanical energy storage system or both a primary and one or more secondary mechanical energy storage systems that actually drive the flywheel from energy stored in the vehicle.

8. The apparatus as defined in claim 7 wherein said flywheel comprises a driven gear means originating at the center of the ball, that may drive an array of other gears (or direct drive) to operate a generator/alternator for powering a recharge system to restore power to the electric vehicle or self-contained mobile battery power system.

9. The apparatus as defined in claim 8 wherein said flywheel assembly comprises;
a ball mounting means to allow selectively minimal restricted rotation about a vertical axis which is separate from (or in addition to) its power transmission axis to alleviate the gyroscopic forces of the flywheel causing directional inertia in relation to the vehicle;
a ball bearing means on the leverage end of the axis of rotation mounted within an elastic medium for the control of imbalance induced vibrations;
a configuration of actuators spaced at angular relationship from the said ball bearing mounting means for the management of gyroscopic forces of the flywheel due to the movement characteristics of the vehicle.

10. The apparatus as defined in claim 9 whereas the ball means comprises;
a hollow cavity within the ball which provides the power output location near the center of the ball for the flywheel motion to be transferred to drive the generator through a constant velocity type joint, and;
a spline or ball-driver type coupling to transmit the rotary motion from the flywheel ball to the driven load at angles which may be varied from straight alignment.

11. The apparatus as defined in claim 9 wherein another said mounting means comprises;
an indirect coupling between;
a flywheel mounting ball;
a flywheel elastic ball bearing mounting system;
a flywheel inertia management actuator system, and;
an electric vehicle chassis;
a forward pivot for a sub-carriage to alleviate the straight line inertia of the vehicle due to the high density battery weight concentrated near the end of the vehicle, by allowing the vehicle to change directions prior to the disruption of the direction of the battery inertia, and to let the battery carrier follow the path of the vehicle, towed;
an arrangement of springs to the forward pivot to determine the affect that the sub-carriage transmits motion to the vehicle chassis.

12. The apparatus as defined in claim 9 wherein;
a mechanical charge of compression energy to tighten the mechanical charging nut,
a means to provide energy for storage within the vehicle, from an outside source, so the release of energy at a later time, having;
a conduction means comprising a means for a retractable sliding contact group that draws power from the outside source while vehicle is at rest or moving slowly;

13. The apparatus as defined in claim 11 wherein a means for battery carriage replacement comprises;
a jack assembly to house an extensible jack with dolly wheel for changing out the battery on its carrier as a component;
a means for rapid disconnecting the high current rated battery termination at no load for battery change out and the positioning and stabbing of the high current termination upon installation of the next battery;
a disconnect coupling means to separate the battery carriage from the vehicle that is separate from the pivot point sub-carriage coupling.

14. The apparatus as defined in claim 13 whereas the main battery is comprised of portions which are electrically separable, comprising;
a switching means to allow a portion or portions to be electrically sectionalized and isolated from the battery circuit which is to provide power to the motor controller to cause intentional interruption in load,
a portion of the main battery while and the flywheel battery which is useable in place of the isolated from service battery portion, and;
a flywheel battery for substitute, temporary power application to the electric vehicle.

15. The flywheel as defined in claim 14 wherein another electrical power conduction and switching means comprises;
a circuit for the flywheel driven generator to supply voltage to,
a battery charger onboard the E-V to recharge the battery or applicable portions thereof.

16. The apparatus as defined in claim 10 wherein,
a battery may be of the special made embodiment integral to the rotating element of the flywheel or individual, or;
an assembly of commercial-off-the-shelf battery units installed within the said flywheel assembly, with slip rings and brushes for electrical power conduction from the rotating battery portion, comprising;
a number of cells, positioned about the circumference;
a tell-tale indicator wrapped around the circumference with one end fixed to the circumference and,
an opposite end marked in reference to a position such that any expansion of the battery cells or framework caused dislocation of the opposite end of the tale-tale to indicate abnormality.

17. The apparatus as defined in claim 16 wherein said battery in one embodiment having;
a loose liquid electrolyte comprises reservoirs for displaced liquid electrolyte of each cell near the center for when the flywheel is not in motion, such that the electrolyte may be pumped by centrifugal force after the onset of flywheel rotary motion.
